(19) United States
(12) Patent Application Publication
(10) Pub. No.: US 2013/0177767 A1
(43) Pub. Date: Jul. 11, 2013

(54) APPARATUS FOR LAYER-BY-LAYER PRODUCTION OF THREE-DIMENSIONAL OBJECTS

(71) Applicants: Maik GREBE, Bochum (DE); Wolfgang DIEKMANN, Waltrop (DE); Juergen KREUTZ, Marl (DE)

(72) Inventors: Maik GREBE, Bochum (DE); Wolfgang DIEKMANN, Waltrop (DE); Juergen KREUTZ, Marl (DE)

(21) Appl. No.: 13/733,465

(22) Filed: Jan. 3, 2013

(30) Foreign Application Priority Data
Jan. 6, 2012 (DE) 10 2012 200 161.1

(51) Int. Cl. B22F 3/00; B29C 67/00; B32B 5/16; B22F 3/16

(52) U.S. Cl. CPC B22F 3/003; B22F 3/16; B29C 67/0077; B32B 5/16
USPC 428/411.1; 425/78; 419/55; 75/228; 425/174.4; 264/497

(57) ABSTRACT

An apparatus for the layer-by-layer production of three-dimensional objects having a material application unit containing a doctor blade with an edge closest to the construction field having a non-continuous straight line. In one embodiment the blade may vibrate. A process for layer-by-layer production, wherein the construction field is completely coated with applied powder prior to irradiation is also provided. Three dimensional articles made according to the invention are also provided.

### CROSS REFERENCE TO RELATED APPLICATIONS

This application claims priority to German Application No. 10 2012 200 161.1, filed Jan. 6, 2012, the disclosure of which is incorporated herein by reference in its entirety.

### BACKGROUND OF THE INVENTION

1. Field of the Invention

The present invention relates to an apparatus for the layer-by-layer production of three-dimensional objects, to processes for layer-by-layer production, and also to corresponding shaped articles.

2. Description of the Related Art

The rapid provision of prototypes is a task frequently encountered in very recent times. Processes which permit this are termed rapid prototyping/rapid manufacturing, or else additive fabrication processes. Particularly suitable processes use operations based on pulverulent materials, where the desired structures are produced layer by layer, by selective melting and solidifying. Supportive structures for overhangs and undercuts are not needed in this method, since the plane of the construction field that surrounds the melted regions provides sufficient support. The subsequent operation of removing supports is likewise omitted. The processes are also suitable for producing short runs. The temperature of the construction chamber may be selected such that no warpage of the structures produced layer by layer occurs during the construction procedure.

One process which is especially suitable for the purposes of rapid prototyping is selective laser sintering (SLS). In this process, plastics powders in a chamber are exposed briefly and selectively to a laser beam, and this causes melting of the powder particles impacted by the laser beam. The melted particles coalesce and rapidly resolidify to give a solid mass. Three-dimensional bodies can be produced simply and rapidly by this process, by repeatedly exposing a constant succession of freshly applied layers to light.

The laser sintering (rapid prototyping) process for producing shaped articles from pulverulent polymers is described in detail in U.S. Pat. No. 6,136,948 and WO 96/06881 (both DTM Corporation). A wide variety of polymers and copolymers is described as suitable for this application, and include polyacetate, polypropylene, polyethylene, ionomers and polyamide.

Other highly suitable processes are the SIB process (selective inhibition of bonding) as described in WO 01/38061, or a process as described in EP 1015214. Both processes operate with extensive infrared heating to melt the powder. The selectivity of the melting operation is achieved in the first case by the application of an inhibitor and in the second process by a mask. DE 10311438 describes a further process, wherein the energy needed for melting is introduced by a microwave generator, and the selectivity is achieved by application of a susceptor. A further process is described in WO 2005/105412, where the energy needed for melting is introduced as electromagnetic radiation, and, likewise, the selectivity is achieved by application of an absorber.

A problem with the process described above is that the powders used must be pourable, in order to allow flawless layer application. Only if layer application is flawless is it possible to produce three-dimensional objects of high quality. If pourability is inadequate, regions of the construction field are coated inadequately, or not at all, with powder. Moreover, channels, waves or fissures may appear in the powder bed. In processing, this leads to problems, and so at the end of the process the three-dimensional objects produced exhibit defects.

The pourability of the powders employed can be improved by addition of additives, as described in EP 1443073. A disadvantage of this procedure is that the additives added are then also part of the three-dimensional objects produced, and in certain applications this may be undesirable for these objects. Moreover, adding additives to raise the pourability usually also has the effect of increasing warpage in the three-dimensional objects produced. Furthermore, very fine powders cannot be made pourable or can be given only limited pourability, even with the addition of additives. However, it would be desirable to use very fine powders, in order to increase the surface quality of the components and to minimize the warpage tendency.

### SUMMARY OF THE INVENTION

It is an object of the present invention, therefore, to improve the application of low-pourability powders in the production of three-dimensional objects.

It is a further object to provide an apparatus for the preparation of three dimensional objects by a layer by layer method.

It is a still further object of the present invention to provide a method for layer by layer production of three dimensional objects or articles which may employ powders having low-pourability.

These and other objects have been achieved by the present invention, the first embodiment of which includes an apparatus for layer-by-layer production of three-dimensional objects, comprising:

a construction chamber having a planar base;

an adjustable-height construction platform comprising a construction field contingent with the planar base,

an electromagnetic radiation source having a control unit and a lens; and

a moveable material application unit on the planar base, the unit comprising a doctor blade;

wherein

a beam of electromagnetic radiation emitted from the source is focused by the lens on an object area of the construction platform,

a height of the construction platform is adjustable in a downward direction perpendicular to the planar base,

the material application unit slides in a direction across the construction field,

the doctor blade of the material application unit is moveable in a direction parallel to the plane of the base and in a direction perpendicular to the direction of material application, and

an edge of the doctor blade closest to the construction field is a non-continuous straight line.

In one preferred embodiment, the edge of the doctor blade comprises at least two recesses and a geometric shape of the recesses is selected from the group consisting of semicircular, triangular, trapezoidal and rectangular.

In another embodiment the present invention provides a process for layer-by-layer production of three-dimensional objects, comprising:

applying a powder layer onto a construction platform having a planar base;

irradiating the powder with a beam of electromagnetic radiation to fuse the powder in an object pattern;

solidifying the fused powder; and

repeating the powder layer application, irradiation and solidification the obtain a three-dimensional object;

wherein

the powder layer is applied with a moveable material application unit comprising a doctor blade,

an edge of the doctor blade closest to the construction platform is a non-continuous straight line,

the application unit is moved across the construction platform parallel to the planar base, and

the doctor blade is additionally moved in a direction perpendicular to the direction of the application unit across the construction platform and parallel to the planar construction platform.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a schematic diagram of an apparatus for layer-by-layer production of a three dimensional object.

FIG. 2A shows a schematic diagram of a conventional application apparatus.

FIG. 2B shows a side elevation of the apparatus shown in FIG. 2A.

FIG. 3A shows a front elevation of another conventional application apparatus.

FIG. 3B shows a side elevation of the apparatus shown in FIG. 3A.

FIG. 4A shows a front elevation of one embodiment of the present invention.

FIG. 4B shows the edge of a wiper according to an embodiment of the present invention.

FIG. 5A shows a front elevation of another embodiment of the present invention.

FIG. 5B shows another edge of a wiper according to an embodiment of the present invention.

FIG. 6A shows a front elevation of another embodiment of the application apparatus according to the invention.

FIG. 6B shows a plan view of another edge of another embodiment of the present invention.

FIG. 6C shows still another plan view of an edge of according to an embodiment of the present invention.

FIG. 7A shows a front elevation of a preferred embodiment of the powder application unit of the present invention.

FIG. 7B shows a side elevation for the embodiment shown in FIG. 7A.

### DETAILED DESCRIPTION OF THE PREFERRED EMBODIMENTS

In a first embodiment the present invention provides an apparatus for layer-by-layer production of three-dimensional objects, comprising:

a construction chamber having a planar base;

an adjustable-height construction platform comprising a construction field contingent with the planar base,

an electromagnetic radiation source having a control unit and a lens; and

a moveable material application unit on the planar base, the unit comprising a doctor blade;

wherein

a beam of electromagnetic radiation emitted from the source is focused by the lens on an object area of the construction platform,

a height of the construction platform is adjustable in a downward direction perpendicular to the planar base,

the material application unit slides in a direction across the construction field,

the doctor blade of the material application unit is moveable in a direction parallel to the plane of the base and in a direction perpendicular to the direction of material application, and

an edge of the doctor blade closest to the construction field is a non-continuous straight line.

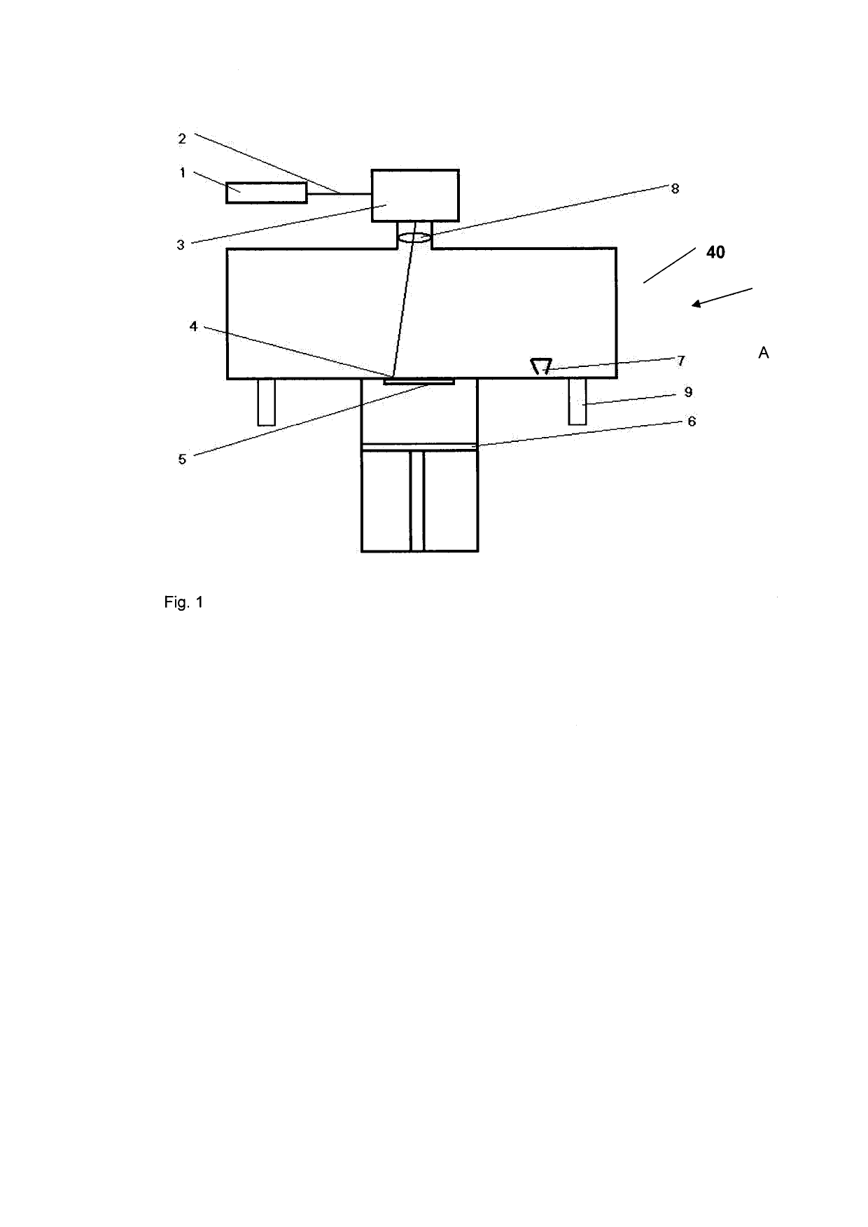

As shown in FIG. 1, the apparatus for the layer-by-layer production of three-dimensional objects (moulds), according to the present invention comprises a construction chamber (40) with an adjustable-height construction platform (6), with an apparatus (7) for applying, to the construction platform (6), a layer of a material solidifiable by exposure to electromagnetic radiation, and with irradiation equipment comprising a radiation source (1) which emits electromagnetic radiation, a control unit (3) and a lens (8) which is located in the beam path of the electromagnetic radiation, for irradiating points of the layer corresponding to the object (5). The application apparatus (7) for applying a layer is configured as a slider (doctor blade) having an edge (26) facing the layer (the field of construction) of a material solidifiable by exposure to electromagnetic radiation, hereinafter called powder. The edge (26) is configured as a non-continuous straight line and can be moved perpendicular to the direction of application and parallel to the plane of the construction field. The slider therefore has recesses which face the plane of the construction field. The recesses constitute regions in the slider through which the solidifiable material is applied over the full area to the construction platform. The arrangement of the recesses is preferably regular.

The “corresponding points” of the object may each constitute a layer of the sliced contour of the object, which are to be melted or sintered into the powder bed in steps by the driving of the laser beam.

The recesses may take on various geometric shapes. For example, the recesses may be semicircular, triangular, trapezoidal or rectangular. There may preferably be at least two, more preferably, at least five, and most preferably, at least ten recesses included. Rectangular recesses produce comb-like sliders. Triangular or trapezoidal recesses may lead to beads which are triangular, for example, and which may point with their peaks in the direction of the plane of the construction field.

The inventors have surprisingly found that with an apparatus of the present invention it may be possible to apply low-pourability powders, thereby making it possible to reduce the addition of additives conventionally used to improve pourability or to eliminate the use of such additives entirely. In this respect, it is especially surprising that powders having low pourability may be employed to produce three dimensional objects in an apparatus (7) according to the present invention which is configured in the form of a slider whose edge facing the powder to be applied is configured as a non-continuous straight line and may be moved perpendicular to the direction of application and parallel to the plane of the construction field. Preferably, during powder application, the apparatus may additionally be moved perpendicular to the direction of application and parallel to the plane of the construction field.

FIG. 1 shows the principles of construction of an apparatus for producing three-dimensional objects in accordance with the present invention. The component may be positioned centrally in the construction field. The laser beam (2) from a laser (1) may be deflected by a scanning system (3) through the lens (8) onto a temperature-controlled and inertized—preferably nitrogen-inertized—powder surface (4) of the object (5) to be formed. The lens here may have a function of separating the remaining optical components, such as the mirrors of the scanner, from the atmosphere of the construction chamber. The lens may be configured as an F-theta lens system, to ensure maximum homogeneity of focus over the entire working field. Located within the construction chamber is the apparatus (7) for applying the material to be solidified to the construction platform (6), the application apparatus is configured in the form of a slider whose powder-facing edge is structured as a non-continuous straight line and may be moved perpendicular to the direction of application and parallel to the plane of the construction field.

In a further preferred embodiment, the apparatus may have a heating element for temperature control of the construction chamber. The heating element may be used to control the temperature of the construction chamber to an ideal temperature for producing the three-dimensional object.

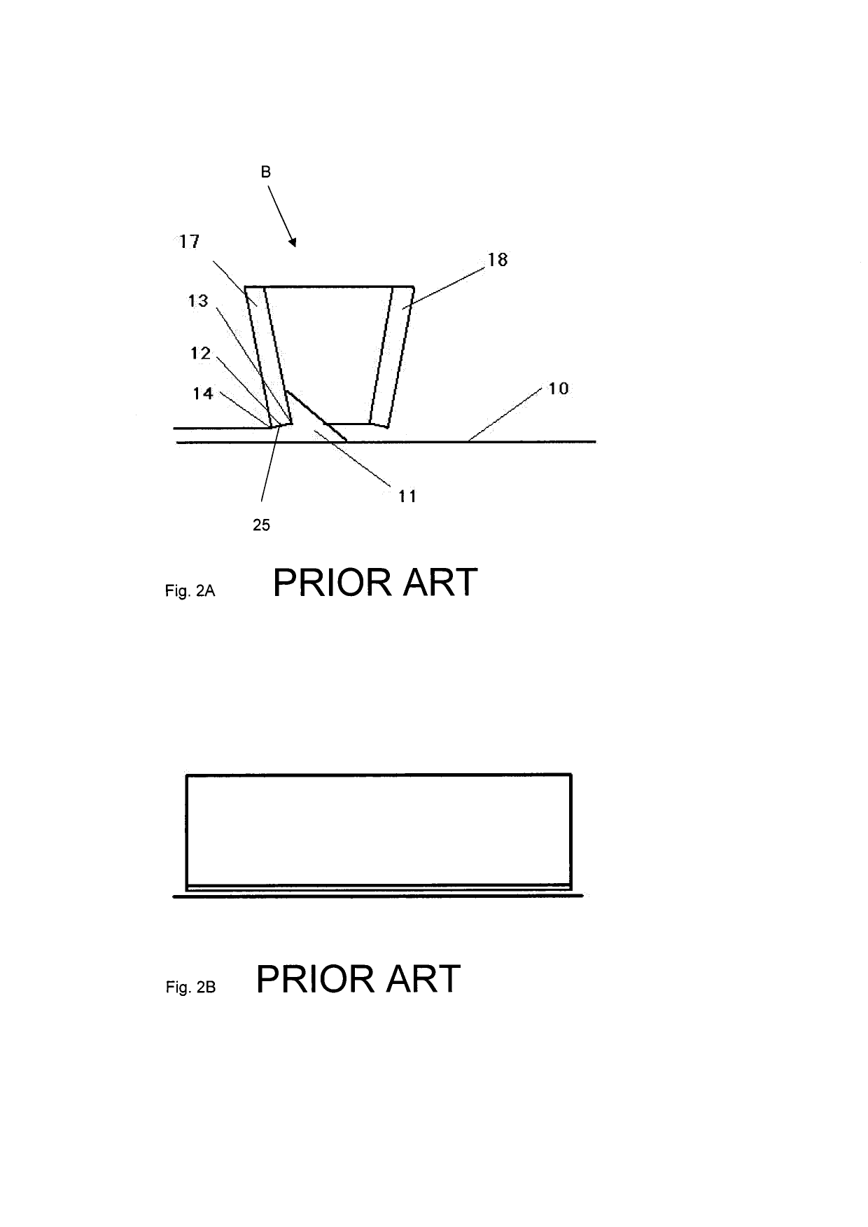

FIG. 2A shows the front elevation of a conventionally employed application apparatus. The application apparatus is configured as a hopper formed by two fixedly connected wipers (17) and (18). The powder is fed to the hopper from above. The part of the application apparatus that is facing the plane of the construction field is a continuous surface (12) without recesses which is bounded by two straight edges (13) and (14). The powder (11) is applied to the preceding layer or to the plane (10) of the construction field. The side elevation of this configuration is shown in FIG. 2B.

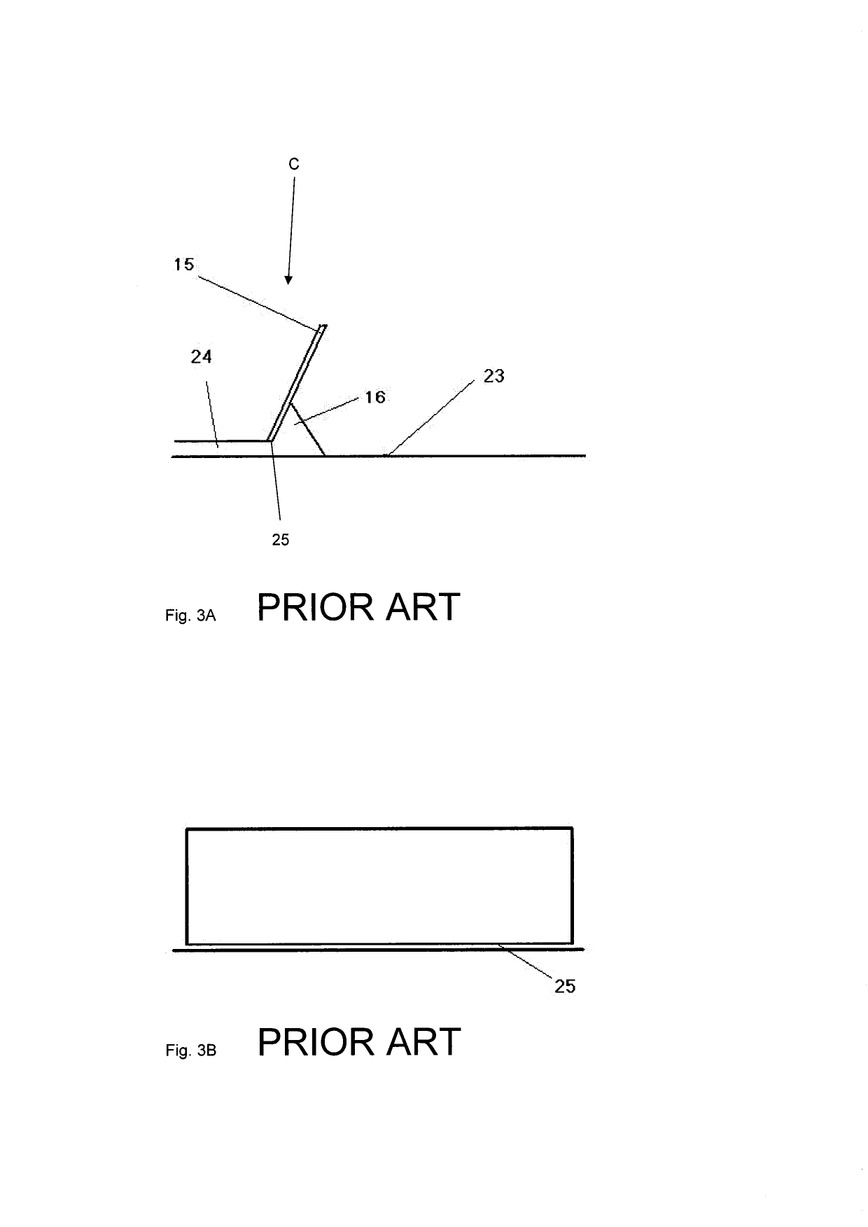

FIG. 3A shows the front elevation of another conventional application apparatus. The application apparatus is configured as a single rectangular wiper (15) without recesses which applies a layer of powder (24). The powder (16) to be applied is spread by the wiper (15) over the preceding layer or the plane (23) of the construction field. The edge (25) facing the plane of the construction field is structured as a continuous surface. The side elevation is shown in FIG. 3B. With this configuration, the powder may be supplied both from below and from above.

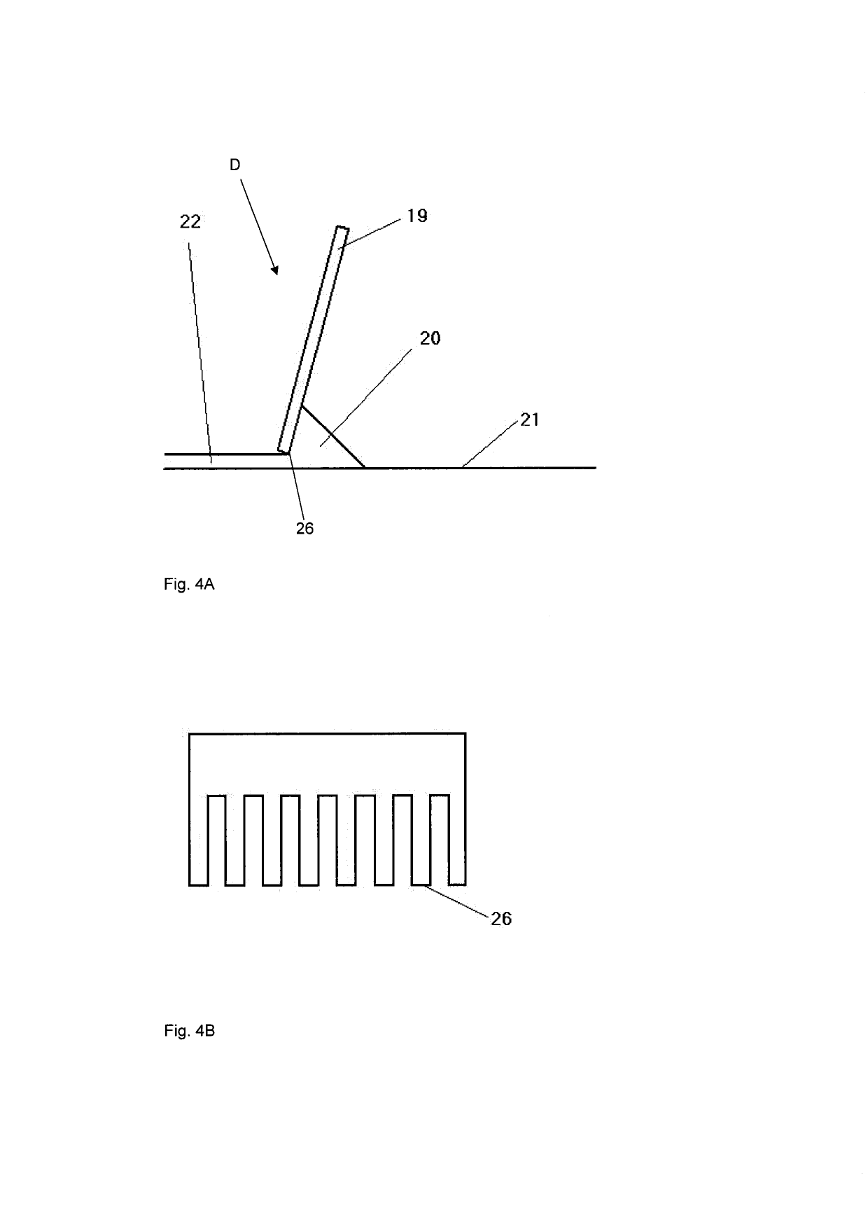

FIG. 4A shows a front elevation of an embodiment of the application apparatus according to the invention. According to this embodiment, the application apparatus may be a single wiper (19) which applies a layer of powder (22). The powder (20) to be applied may be spread by the wiper (19) over the preceding layer or the plane (21) of the construction field. In contrast to conventionally-known processes, the edge of the wiper (26) that faces the plane of the construction field is not configured as a continuous straight line, as is evident from the side elevation shown in FIG. 4B. The fraction of the recessed regions may preferably be not more than 70% and not less than 30%, based on the overall length of the edge facing the plane of the construction field. The fraction of the recessed regions may preferably be between 40% and 60%. More preferably the fraction of the recessed regions may be between 45% and 55%. The apparatus may be mounted in such a way that the apparatus is able to perform a vibratory translational movement whose displacement vector is oriented perpendicular to the direction of coating and parallel to the plane of the construction field. The amplitude of the doctor blade vibration may be from 1 mm to 20 mm, preferably 2 mm to 10 mm, most preferably, 4 mm to 6 mm, and the frequency of the vibration may be from 5 Hz to 300 Hz, preferably, 10 Hz to 200 HZ, and most preferably, 20 Hz to 50 Hz. According to this embodiment, the powder may be supplied both from below and from above.

The wiper may be constructed of any suitable material and may preferably be made of a material which is not reversibly diffracted or deflected while the powder is being applied. A non-elastic plastic or metal may be preferred materials.

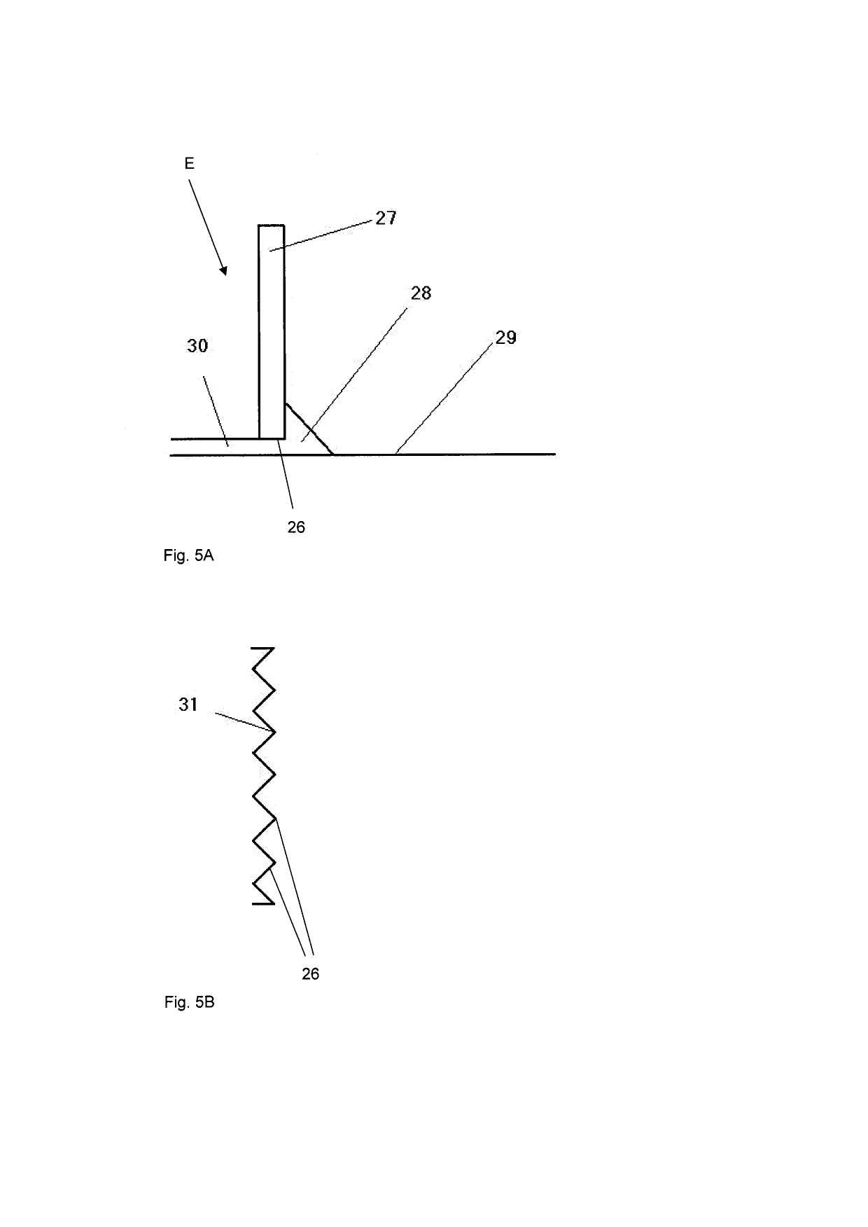

FIG. 5A shows the front elevation of a further embodiment of the apparatus according to the present invention. The application apparatus according to this embodiment may be configured as a single wiper (27) which applies a layer of powder (30). The powder (28) to be applied is spread by the wiper (27) over the preceding layer or the plane (29) of the construction field. In contrast to the conventionally known apparatus, the wiper is not configured as a rectangular planar surface—the application apparatus may preferably have at least at least two and more preferably, at least five beads (31). According to this embodiment, the edge of the wiper that faces the plane of the construction field is likewise not structured as a straight line. This embodiment can be seen in the plan view shown in FIG. 5B. The angle within the peaks of the beads (31) may preferably be less than 150°, more preferably less than 120°, and most preferably less than 90°. The spacing between the peaks of the beads is preferably at least 3 mm and at most 50 mm. These numbers include all ranges and sub-ranges there-between. The apparatus may be mounted such that the apparatus is able to perform a vibratory translational movement whose displacement vector is oriented perpendicular to the direction of coating and parallel to the plane of the construction field. The amplitude of the doctor blade vibration may be from 1 mm to 20 mm, preferably 2 mm to 10 mm, most preferably, 4 mm to 6 mm, and the frequency of the vibration may be from 5 Hz to 300 Hz, preferably, 10 Hz to 200 HZ, and most preferably, 20 Hz to 50 Hz.

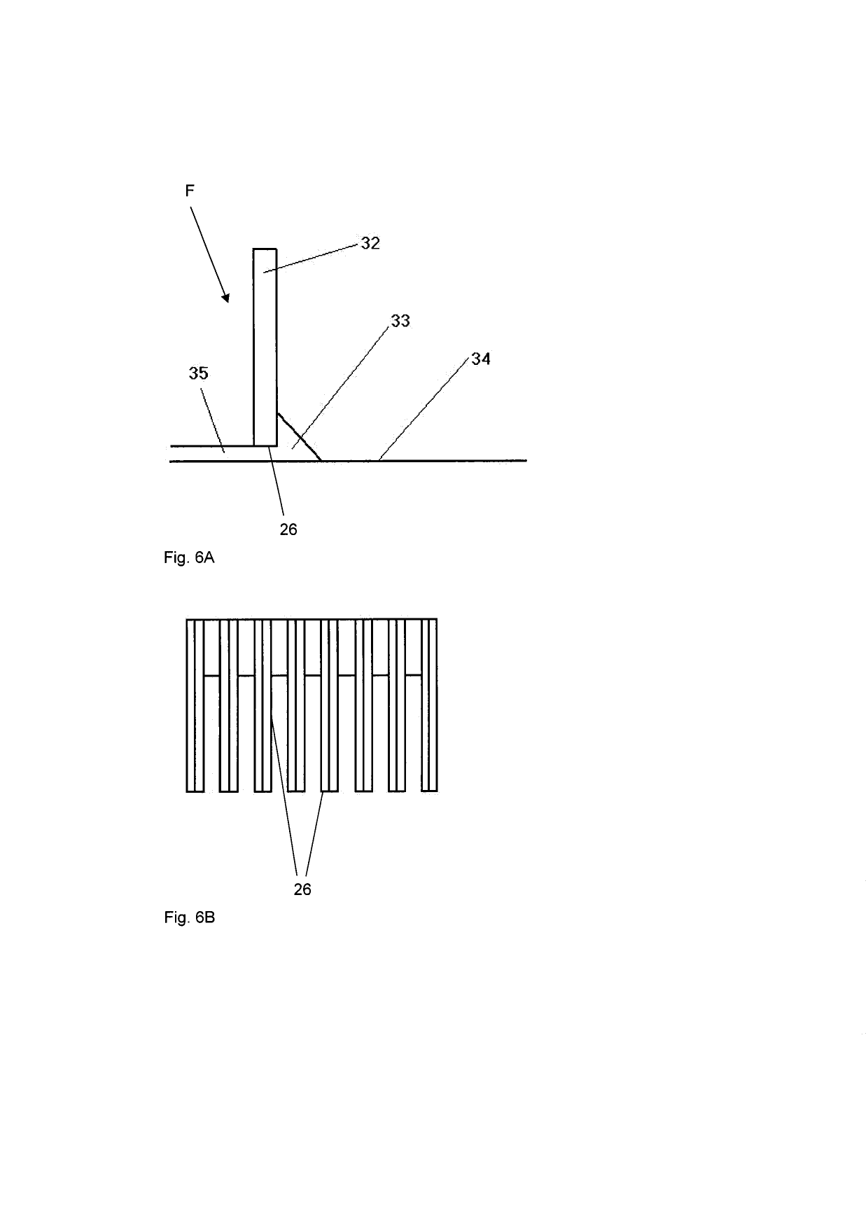

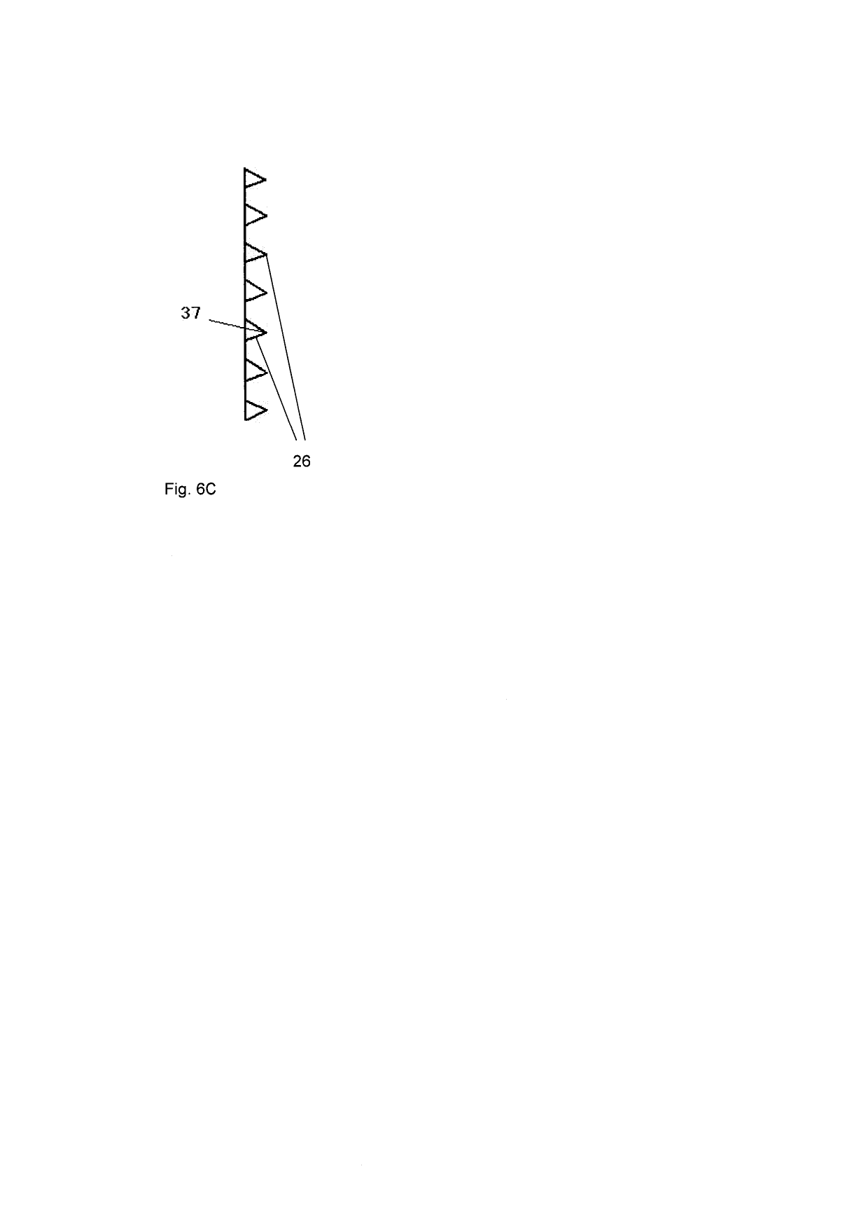

In FIG. 6A, FIG. 6B and FIG. 6C, the front elevation, side elevation and plan view of a further embodiment of the apparatus according to the present invention are shown. The application apparatus according to this embodiment may be configured as a wiper (32) which applies a layer of powder (35). The powder (33) to be applied is spread by the wiper (32) over the preceding layer or the plane (34) of the construction field. In this embodiment, the structure shown in FIG. 4A and FIG. 4B is combined with the embodiment shown in FIG. 5A and FIG. 5B. The apparatus may be mounted such that the apparatus may perform a vibratory translational movement whose displacement vector is oriented perpendicular to the direction of coating and parallel to the plane of the construction field.

For improved powder application it may be possible to combine two or more of the embodiments described above. The recesses in the series of wipers may be designed to allow a continuous powder bed to be established. In this case there may be no need for a vibratory movement of the apparatus.

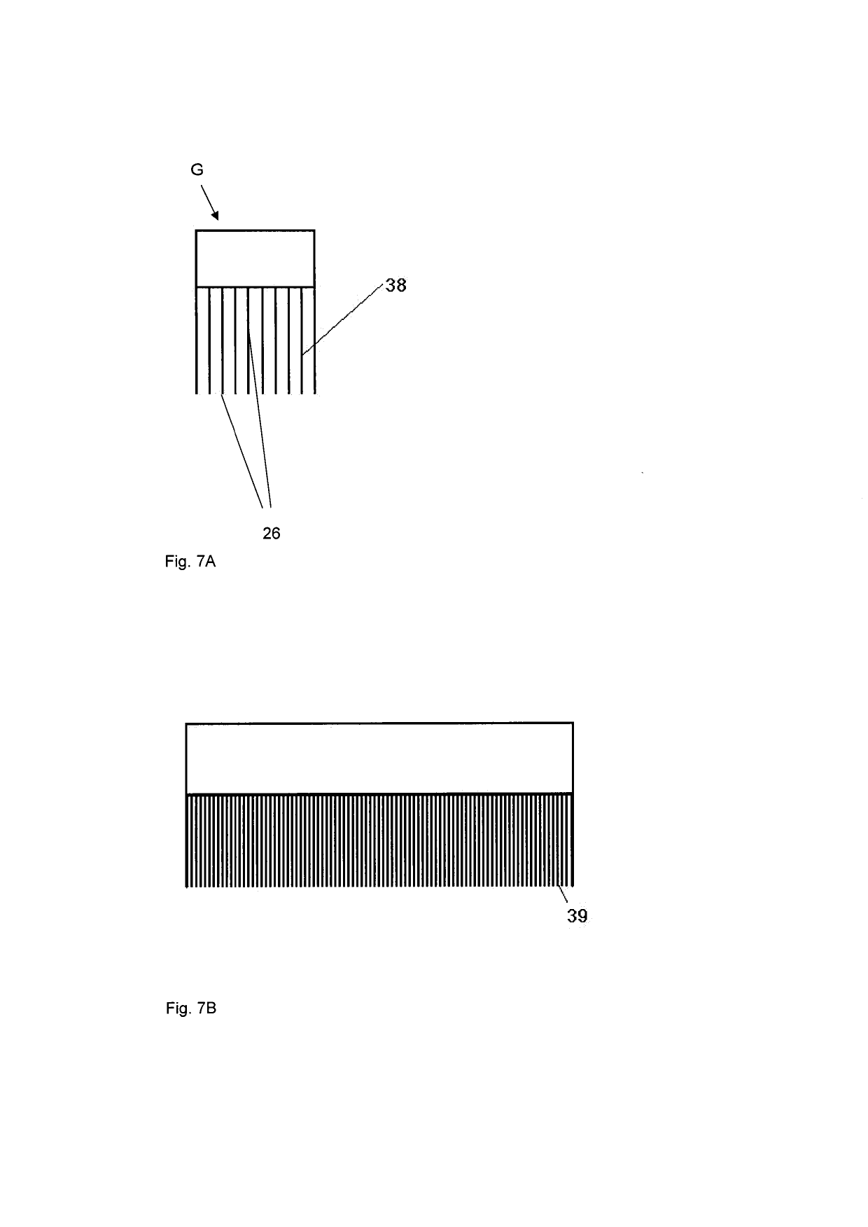

A further embodiment of the invention is shown in FIG. 7A (front elevation) and 7B (side elevation). Powder application is conducted through a plurality of rows (38) of wires (39).

The quality of the applied layer may be additionally enhanced if after the application of powder according to the apparatus of the invention, the plane of the construction field is smoothed by means of a roller or a wiper. The roller or wiper may be constructed from any of metals, ceramics and high-temperature plastics. Suitable high-temperature plastics may be polyimides, polyaryletherketones, polyphenolensulfides, polyarylsulfones and fluor polymers.

In one further embodiment the apparatus for the layer-by-layer production of three-dimensional objects may additionally comprise a vibration generator, which sets the construction platform (6) into vibration, and thus, may increase the density of the powder bed.

In order to further increase the ease of application, the powder may be regularly loosened. This treatment may be accomplished by rotational or translational movement of a conventional apparatus for such purpose through the powder prior to application. This may take place during the application of the powder or during a metering procedure. This measure may counter the formation of lumps in the powder prior to application.

Fine powders which have low pourability or are unpourable, in particular, have a tendency to adhere to an apparatus for powder application. These adhesions then lead, during powder application, to channels in the construction field. These adhesions may be eliminated by use of a stripping apparatus, such a brush. Stripping apparatuses of this kind are known to those skilled in the art. The apparatus for powder application travels over the stripper, and as it does so, the adhesions may be eliminated and then fall into an overflow. The material for the stripper should be selected so as to ensure a sufficient force for eliminating the adhesions on the apparatus for powder application, but such that at the same time there is no damage to the apparatus for powder application. The stripper may consist, for example, of plastic or metal.

In another embodiment, the present invention provides a process for the layer-by-layer production of three-dimensional objects, where the powder is applied to the construction platform or over a previous layer, by an application apparatus (7) according to the invention. According to this embodiment, during powder application force may be placed on the powder not only in the direction of application but also by another force which is directed perpendicular to the direction of coating and parallel to the plane of the construction field. Particularly preferred are processes for the layer-by-layer production of three-dimensional objects, that are conducted in an apparatus comprising a construction chamber (10) with an adjustable-height construction platform (6), with an apparatus (7) for applying, to the construction platform (6), a layer of a powder solidifiable by exposure to electromagnetic radiation, and with irradiation equipment comprising a radiation source (1) which emits electromagnetic radiation, a control unit (3) and a lens (8) which is located in the beam path of the electromagnetic radiation, for irradiating points of the layer corresponding to the object (5), and where, during application of the solidifiable powder, the powder is acted on not only by the force in the direction of application but also by a force which is directed perpendicular to the direction of coating and parallel to the plane of the construction field.

The process according to the present invention may be especially suitable for the application of powders of low-pourability, powders which are non-pourable powders and/or for application of very fine polymer powders.

The processes according to the invention which can produce shaped parts according to the invention from powders are described in more detail below, but without any intention that such description be limiting unless otherwise expressly stated.

In principle, any of the polymer powders known to the person skilled in the art may be suitable for use in the apparatus of the invention or in the process of the invention. Thermoplastic and thermoelastic materials may be particularly suitable, and include polyethylene (PE, HDPE, LDPE), polypropylene (PP), polyamides, polyesters, polyester esters, polyether esters, polyphenylene ethers, polyacetals, polyalkylene terephthalates, in particular polyethylene terephthalate (PET) and polybutylene terephthalate (PBT), polymethyl methacrylate (PMMA), polyvinyl acetal, polyvinyl chloride (PVC), polyphenylene oxide (PPO), polyoxymethylene (POM), polystyrene (PS), acrylonitrile-butadiene-styrene (ABS), polycarbonates (PC), polyether sulphones, thermoplastic polyurethanes (TPU), polyaryletherketones, in particular polyetheretherketone (PEEK), polyetherketoneketone (PEKK), polyetherketone (PEK), polyetheretherketone-ketone (PEEKK), polyaryletheretheretherketone (PEEEK) or polyetherketoneetherketoneketone (PEKEKK), polyetherimides (PEI), polyarylene sulphides, in particular polyphenylene sulphide (PPS), thermoplastic polyimides (PI), polyamideimides (PAT), polyvinylidene fluorides, and also copolymers of the said thermoplastics, such as a polyaryletherketone (PAEK)/polyarylether sulphone (PAES) copolymer, mixtures and/or polymer blends. With special preference, the polymer powder comprises at least one polyamide or polyaryletherketone. An especially preferred polymer powder comprises or consists of polyamide, more particularly PA6, PA66, PA610, PA613, PA1010, PA106, PA11, PA12, PA1012, PA1013 or mixtures of these.

Metallic powders, including iron, titanium or aluminium, or ceramic powders may also be suitable for use according to the present invention. Polymer powders may be particularly preferred.

In operation, an engineering program or the like may be first used to generate or store, in a computer, data concerning the shape of the object (5) to be produced. For the production of the object, the data may be processed in such a way that the object is dissected into a large number of horizontal layers which are thin in comparison with the size of the object, and the shape data are provided for each of this large number of layers, for example in the form of data sets, e.g. CAD data. The generation and processing of the data for each layer may take place prior to the production process or else simultaneously with the production of each layer.

The construction platform (6) is then first moved by the height-adjustment apparatus to the highest position, in which the surface of the construction platform (6) is in the same plane as the surface of the construction chamber, and may then be lowered by an amount corresponding to the intended thickness of the first layer of material in such a way that, within the resultant aperture, a lowered region may be formed, delimited laterally by the walls of the aperture and below by the surface of the construction platform (6). A first layer of the material to be solidified, with the intended layer thickness, may then be introduced by the application apparatus (7) into the cavity formed by the aperture and the construction platform (6), or into the lowered region, and may optionally be heated by a heating system to a suitable operating temperature, for example 100° C. to 360° C., preferably 120° C. to 200° C. The control unit (3) then controls the deflector device in such a way that the deflected light beam (2) successively impacts all points of the layer, and sinters or melts the material there. A solid basal layer can thus first be formed. In a second step, the construction platform (6) is lowered by an amount corresponding to one layer thickness, and a second layer of material is introduced by the application apparatus (7) into the resultant lowered region within the aperture, and optionally in turn heated by the heating system.

In one embodiment, the control unit (3) may control the deflector device in such a way that the deflected light beam (2) impacts only that region of the layer of material that is adjacent to the inner surface of the aperture, and solidifies the layer of material there by sintering, thus producing a first, annular, wall layer with a wall thickness of about 2 to 10 mm which completely surrounds the remaining pulverulent material of the layer. This part of the control system is therefore a device for producing a container wall which surrounds the object (5) to be formed, simultaneously with the formation of the object in each layer.

Once the construction platform (6) has been lowered by an amount corresponding to the layer thickness of the next layer, and the material has been applied and heated in the same manner as above, the production of the object (5) may then begin. For this, the control unit (3) controls the deflector device in such a way that the deflected light beam (2) impacts those points of the layer which, according to the coordinates stored in the control unit for the object (5) to be produced, are intended to be hardened. The procedure for the other layers is analogous. In the case of the desired production of an annular wall region in the form of a container wall which encloses the object together with the remaining, unsintered material and thus inhibits escape of the material when the construction platform (6) is lowered below the work table, the device is used to sinter an annular wall layer onto the annular wall layer located thereunder for each layer of the object. Production of the wall may be omitted if a replaceable vessel according to EP 1037739, or a fixedly installed container, is used.

After cooling, the object formed may be removed from the apparatus.

The present invention also provides three-dimensional objects or components produced by the processes of the invention.

In one embodiment, the present invention provides a method for the layer-by-layer production of three-dimensional objects using polymer powders, having an average grain size d50 of less than 50 μm, and which powder is non-flowable in accordance with DIN EN ISO 6186 (method A, flow diameter 15 mm). Preference may be given to a polymer powder having a d50 value of less than 35 μm which in accordance with DIN EN ISO 6186 is non-flowable. Particularly preferred here is a polymer powder with a d50 value of less than 20 μm which in accordance with DIN EN ISO 6186 is non-flowable.

The d50 value may be measured using a Malvern Mastersizer 2000 (dry measurement, 20-40 g of powder metered in using Scirocco dry dispersion equipment. The vibratory trough feed rate is 70%, and the dispersing-air pressure lies at 3 bar. The sample measurement time is 5 seconds (5000 individual measurements); refractive index and blue-light value are set at 1.52. Evaluation via Mie theory).

The dimensional accuracy of the three-dimensional objects may be increased through use of a polymer powder which has an ISO 9277 BET surface area of at least 6 m²/g, preferably, at least 8 m²/g, and most preferably, at least 10 m²/g.

The BET surface area for the purposes of the present invention may be measured in accordance with ISO 9277, using a Micromeritics TriStar 3000, by gas adsorption of nitrogen in a discontinuous volumetric process: 7 measurement points at relative pressures P/P0 of between about 0.05 and about 0.20, calibration of the dead space by means of He (99.996%), sample preparation of 1 h at 23° C.+16 h at 80° C. under reduced pressure, specific surface area related to the degassed sample. Evaluation may be conducted by a multi-point determination.

Suitable polymer powders are the thermoplastic and thermoelastic materials listed above.

The operations for producing a polymer powder of the invention are known to the person skilled in the art, and include spray drying, melt spraying, anionic polymerization and cold grinding. One particularly suitable method for producing powders in accordance with the present invention may be via reprecipitation, wherein a polymer is dissolved in a suitable solvent and then crystallized out.

It is assumed that a person skilled in the art may use the above description to its fullest extent even in the absence of any further information. The preferred embodiments and examples are therefore to be interpreted merely as descriptive disclosure, and certainly not as in any way limiting disclosure. Having generally described this invention, a further understanding can be obtained by reference to certain specific examples which are provided herein for purposes of illustration only, and are not intended to be limiting unless otherwise specified.

### LIST OF REFERENCE SYMBOLS IN THE FIGURES

A Apparatus for producing three-dimensional objects (FIG. 1)
1 Radiation source, laser
2 Laser beam
3 Scan system
4 Powder surface
5 Object to be formed
6 Construction platform
7 Apparatus for applying a layer of a material solidifiable by exposure to electromagnetic radiation
8 Lens
9 Overflow vessel
40 Construction chamber
B Application apparatus (prior art; FIG. 2A, 2B)
10 Plane of the construction field
11 Powder (to be applied)
12 Continuous area without recesses
13 First straight edge
14 Second straight edge
17 Wiper
18 Wiper
19 Edge facing the plane of the construction field
C Application apparatus (prior art; FIG. 3A, 3B)
15 Wiper
16 Powder (to be applied)
23 Plane of the construction field
24 Powder (to be applied)
25 Edge facing the plane of the construction field
D Inventive application apparatus (FIG. 4A, 4B)
19 Wiper
20 Powder (to be applied)
21 Plane of the construction field
22 Powder layer
26 Edge of the wiper
E Inventive application apparatus (FIG. 5A, 5B)
26 Edge of the wiper
27 Wiper
28 Powder (to be applied)
29 Plane of the construction field
30 Powder layer
31 Beads
F Inventive application apparatus (FIG. 6A-6C)
26 Edge of the wiper
32 Wiper
33 (Powder to be applied)
34 Plane of the construction field
35 Powder layer
36 Beads
G Inventive application apparatus (FIG. 7A, 7B)
26 Edge of the wiper
38 Rows of wires
39 Wires

### EXAMPLES

The examples were conducted in accordance with the description below unless indicated otherwise. The construction chamber was preheated for 180 min to a temperature which was 20° C. below the process temperature. The temperature in the construction chamber was then increased to the process temperature. The temperature distribution in the construction chamber was not always homogeneous, and the temperature measured by means of a pyrometer was therefore defined as construction-chamber/process temperature. Prior to the first exposure to light, 40 layers of powder with a layer thickness in each case of 150 μm were applied. The laser beam (2) from the laser (1) was deflected by means of a scanning system (3) through the lens (8) onto the temperature-controlled and inertized (N2) plane (4) of the construction field. The lens was configured as an F-theta lens system, in order to ensure an extremely homogeneous focus over the entire construction-field plane.

The component to be exposed to light was positioned centrally in the construction field. A square area with edge length 50 mm was melted by means of the laser. The construction platform (6) was then lowered by 0.15 mm, and a fresh powder layer applied at a velocity of 100 mm/s by means of a customary application apparatus or the slider (7) of the invention. The corresponding points are then laser-sintered. The said steps were repeated until a three-dimensional component (5) of height 50 mm was produced. After the exposure to light was concluded, 40 further layers were applied before the heating elements were switched off and the cooling phase initiated. The time needed for each layer during the entire construction process was below 40 seconds.

After a cooling time of at least 12 hours, the component was removed and freed from the adhering powder.

### Example 1

### Not According to the Invention

The construction process was carried out in an EOSINT P360 from EOS GmbH. A PA12 powder with the powder properties shown in Table 1 was processed. The powder was applied with the coating apparatus of the EOSINT P360, as shown in FIG. 2. The quality of the applied powder layers was poor. Channels were visible in the construction field. At certain points in the plane of the construction field, too little powder was applied, or none. The process temperature was 169° C. The exposure parameters were as follows: laser power 19.0 W, scan velocity 1100 mm/s, distance between exposure lines 0.3 mm. The three-dimensional object produced had severe surface defects.

### Example 2

### Not According to the Invention

The construction process was carried out in an EOSINT P380 from EOS GmbH. A PA12 powder with the powder properties shown in Table 1 was processed. The powder was applied with the coating apparatus of the EOSINT P380, as shown in FIG. 2. The quality of the applied powder layers was poor. Channels were visible in the construction field. At certain points in the plane of the construction field, too little powder was applied, or none. The process temperature was 170° C. The exposure parameters were as follows: laser power 36.0 W, scan velocity 2000 mm/s, distance between exposure lines 0.3 mm. The three-dimensional object produced had severe surface defects.

### Example 3

### Not According to the Invention

The construction process was carried out in a FORMIGA from EOS GmbH. A PA12 powder with the powder properties shown in Table 1 was processed. The powder was applied with a conventional coating apparatus of the FORMIGA, as shown in FIG. 3A/3B, in accordance with conventional methods. The quality of the applied powder layers was poor. In large regions in the plane of the construction field, too little powder was applied, or none. It was not possible to produce a three-dimensional object. The process temperature was 166° C.

### Example 4

### Not According to the Invention

The construction process was carried out in an EOSINT P360 from EOS GmbH. A PP powder with the powder properties shown in Table 3 was processed. The powder was applied with the coating apparatus of the EOSINT P360, as shown in FIG. 2. The quality of the applied powder layers was poor. Deep channels were visible in the construction field. At numerous points in the plane of the construction field, too little powder was applied, or none. The process temperature was 123° C. It was not possible to produce a three-dimensional object.

### Example 5

### Not According to the Invention

The construction process was carried out in an EOSINT P360 from EOS GmbH. A PEEK powder with the powder properties shown in Table 4 was processed. The powder was applied with the coating apparatus of the EOSINT P360, as shown in FIG. 2. The process temperature was 199° C. The quality of the applied powder layers was poor and it was not possible to apply a continuous powder layer.

### Example 6

### According to the Invention

The trial was carried out in the construction chamber of an EOSINT P360 from EOS GmbH. A PA12 powder with the powder properties shown in Table 1 was processed. The process temperature was 169° C. The powder was applied using an apparatus in which 4 wipers were mounted in series at a distance of 10 mm. The geometry of the individual wipers is shown in FIG. 4A/4B. The recesses were each 10 mm wide. The fraction of the recessed regions was 50%. The apparatus performed a vibratory translational movement with an amplitude of 4 mm and a frequency of 10 Hz, the displacement vector of which was oriented perpendicular to the direction of coating and parallel to the plane of the construction field, thereby ensuring a uniform distribution of the powder. The powder was readily applied. The construction-field plane was coated completely. The exposure parameters were as follows: laser path 36.0 W, scan velocity 2000 mm/s, distance between exposure lines 0.3 mm. The three-dimensional object produced did not have any surface defects.

### Example 7

### According to the Invention

The trial was carried out in the construction chamber of an EOSINT P360 from EOS GmbH. A PA12 powder with the powder properties shown in Table 1 was processed. The process temperature was 169° C. The powder was applied using an apparatus whose geometry is shown in FIG. 5A/5B. The angle of the peaks of the beads was 90°. The apparatus performed a vibratory translational movement with an amplitude of 1 mm and a frequency of 100 Hz, the displacement vector of which was oriented perpendicular to the direction of coating and parallel to the plane of the construction field. The powder was readily applied. The construction-field plane was coated completely. The exposure parameters were as follows: laser path 36.0 W, scan velocity 2000 mm/s, distance between exposure lines 0.3 mm. The three-dimensional object produced did not have any surface defects.

### Example 8

### According to the Invention

The trial was carried out in the construction chamber of an EOSINT P360 from EOS GmbH. A PA12 powder with the powder properties shown in Table 1 was processed. The process temperature was 169° C. The powder was applied using an apparatus in which 2 wipers were mounted in series at a distance of 25 mm. Mounted behind the wipers was a steel roller (diameter 25 mm) for smoothing the plane of the construction field. The geometry of the individual wipers is shown in FIG. 6A/6B/6C. The recesses were each 12 mm wide. The fraction of the recessed regions was 55%. The angle of the peaks of the beads was 80°. The apparatus performed a vibratory translational movement with an amplitude of 4 mm and a frequency of 20 Hz, the displacement vector of which is oriented perpendicular to the direction of coating and parallel to the plane of the construction field. The powder was readily applied. The construction-field plane was coated completely. The exposure parameters were as follows: laser path 36.0 W, scan velocity 2000 mm/s, distance between exposure lines 0.3 mm. The three-dimensional object produced did not have any surface defects.

### Example 9

### According to the Invention

The trial was carried out in the construction chamber of an EOSINT P360 from EOS GmbH. A PA12 powder with the powder properties shown in Table 1 was processed. The process temperature was 169° C. The powder was applied using a comb-like apparatus as shown in FIG. 7A/7B. The apparatus consisted of 10 rows (row spacing 3 mm) of brass bristles (bristle length 20 mm, diameter 1 mm, 60 bristles per 100 mm length). The apparatus performed a vibratory translational movement with an amplitude of 2 mm and a frequency of 100 Hz, the displacement vector of which was oriented perpendicular to the direction of coating and parallel to the plane of the construction field. The powder was readily applied. The construction-field plane was coated completely. The exposure parameters were as follows: laser path 36.0 W, scan velocity 2000 mm/s, distance between exposure lines 0.3 mm. The three-dimensional object produced did not have any surface defects.

### Example 10

### According to the Invention

The trial was carried out in the construction chamber of an EOSINT P360 from EOS GmbH. A PA6 powder with the powder properties shown in Table 2 was processed. The powder was applied using a comb-like apparatus as shown in FIG. 7A/7B. The apparatus consisted of 8 rows (row spacing 3 mm) of brass bristles (bristle length 20 mm, diameter 1 mm, 60 bristles per 100 mm length). The apparatus performed a vibratory translational movement with an amplitude of 1 mm and a frequency of 200 Hz, the displacement vector of which was oriented perpendicular to the direction of coating and parallel to the plane of the construction field. The powder was readily applied. The construction-field plane was coated completely. The process temperature was 199° C. The exposure parameters were as follows: laser path 36.0 W, scan velocity 2000 minis, distance between exposure lines 0.3 mm. The three-dimensional object produced does not have any surface defects.

### Example 11

### According to the Invention

The trial was carried out in the construction chamber of an EOSINT P360 from EOS GmbH. A PP powder with the powder properties shown in Table 3 was processed. The process temperature was 123° C. The powder was applied using an apparatus in which 3 wipers were mounted in series at a distance of 20 mm. The geometry of the first two wipers is shown in FIG. 6A/6B/6C. The third wiper was configured in accordance with FIG. 5A/5B. The recesses of the first two wipers were each 12 mm wide. The fraction of the recessed regions was 55%. The angle in the peaks of the beads was 80° in each case. The apparatus performed a vibratory translational movement with an amplitude of 2 mm and a frequency of 50 Hz, the displacement vector of which was oriented perpendicular to the direction of coating and parallel to the plane of the construction field. The powder was readily applied. The construction-field plane was coated completely. The exposure parameters were as follows: laser path 36.0 W, scan velocity 2000 mm/s, distance between exposure lines 0.3 mm. The three-dimensional object produced did not have any surface defects.

### Example 12

### According to the Invention

The trial was carried out in the construction chamber of an EOSINT P360 from EOS GmbH. A PEEK powder with the powder properties shown in Table 4 was processed. The process temperature was 199° C. The powder was applied using an apparatus in which 3 wipers were mounted in series at a distance of 20 mm. The geometry of the first two wipers is shown in FIG. 6A/6B/6C. The third wiper was configured in accordance with FIG. 5A/5B. The recesses of the first two wipers were each 12 mm wide. The fraction of the recessed regions was 55%. The angle in the peaks of the beads was 80° in each case. The apparatus performed a vibratory translational movement with an amplitude of 5 mm and a frequency of 40 Hz, the displacement vector of which was oriented perpendicular to the direction of coating and parallel to the plane of the construction field. The powder is readily applied. The construction-field plane was coated completely.

TABLE 1
Properties of PA12 powder

| | Value | Unit | Test type/Test equipment/Test parameters |
|---|---|---|---|
| Polymer | Polyamide 12 | | |
| Bulk density | 0.355 | g/cm³ | DIN EN ISO 60 |
| Grain size d50 | 18 | μm | Malvern Mastersizer 2000, dry measurement, 20-40 g |
| | | | of powder added by means of Scirocco dry |
| | | | dispersion equipment. |
| | | | Feed rate vibratory trough 70%, dispersion air |
| | | | pressure 3 bar. Specimen measurement time |
| | | | 5 seconds (5000 individual measurements), |
| | | | refractive index and blue-light value defined as |
| | | | 1.52. |
| | | | Evaluation by way of Mie theory |
| Grain size d10 | 11 | μm | Malvern Mastersizer 2000, parameters: see grain |
| | | | size d50 |
| Grain size d90 | 38 | μm | Malvern Mastersizer 2000, parameters: see grain |
| | | | size d50 |
| <10.48 μm | 9 | % | Malvern Mastersizer 2000, parameters: see grain |
| | | | size d50 |
| Pourability | Does not flow | s | DIN EN ISO 6186, Method A, nozzle outlet |
| | under test | | diameter 15 mm |
| | conditions | | |
| Solution | 1.53 | — | ISO 307, Schott AVS Pro, solvent acidic m-cresol, |
| viscosity | | | volumetric method, two measurements, dissolution |
| | | | temperature 100° C., dissolution time 2 h, polymer |
| | | | concentration 5 g/l, measurement temperature 25° C. |
| BET (spec. | 10.2 | m²/g | ISO 9277, Micromeritics TriStar 3000, nitrogen gas |
| surface area) | | | adsorption, discontinuous volumetric method, 7 |
| | | | measurement points at relative pressures P/P0 from |
| | | | about 0.05 to about 0.20, dead volume calibration |
| | | | by means of He(99.996%), specimen preparation |
| | | | 1 h at 23° C. + 16 h at 80° C. in vacuo, spec. surface |
| | | | area based on devolatilized specimen, evaluation by |
| | | | means of multipoint determination |
| Melting point, | 182 | ° C. | DIN 53765 DSC 7 v. Perkin Elmer, heating/cooling |
| 1^{st} heating | | | rate 20 K/min |
| procedure | | | |
| Recrystallization | 139 | ° C. | DIN 53765 DSC 7 v. Perkin Elmer, heating/cooling |
| temperature | | | rate 20 K/min |

TABLE 2
Properties of PA6 powder

| Conditioning | Material is stored for 24 h at 23° C. and 50% humidity prior to | | |
|---|---|---|---|
| of the material | processing/analysis | | |
| | Value | Unit | Test type/Test equipment/Test parameters |
| Polymer | Polyamide 6 | | |
| Bulk density | 0.361 | g/cm³ | DIN EN ISO 60 |
| Grain size d50 | 30 | μm | Malvern Mastersizer 2000, dry measurement, 20-40 g |
| | | | of powder added by means of Scirocco dry |
| | | | dispersion equipment. |
| | | | Feed rate vibratory trough 70%, dispersion air |
| | | | pressure 3 bar. Specimen measurement time |
| | | | 5 seconds (5000 individual measurements), |
| | | | refractive index and blue-light value defined as |
| | | | 1.52. |
| | | | Evaluation by way of Mie theory |
| Grain size d10 | 12 | μm | Malvern Mastersizer 2000, parameters: see grain |
| | | | size d50 |
| Grain size d90 | 52 | μm | Malvern Mastersizer 2000, parameters: see grain |
| | | | size d50 |
| <10.48 μm | 7 | % | Malvern Mastersizer 2000, parameters: see grain |
| | | | size d50 |
| Pourability | Does not flow | s | DIN EN ISO 6186, Method A, nozzle outlet |
| | under test | | diameter 15 mm |
| | conditions | | |
| Solution | 1.62 | — | ISO 307, Schott AVS Pro, solvent sulphuric acid, |
| viscosity | | | volumetric method, two measurements, dissolution |
| | | | temperature 100° C., dissolution time 2 h, polymer |
| | | | concentration 5 g/l, measurement temperature 25° C. |
| BET (spec. | 6.5 | m²/g | ISO 9277, Micromeritics TriStar 3000, nitrogen gas |
| surface area) | | | adsorption, discontinuous volumetric method, 7 |
| | | | measurement points at relative pressures P/P0 from |
| | | | about 0.05 to about 0.20, dead volume calibration |
| | | | by means of He(99.996%), specimen preparation |
| | | | 1 h at 23° C. + 16 h at 80° C. in vacuo, spec. surface |
| | | | area based on devolatilized specimen, evaluation by |
| | | | means of multipoint determination |
| Melting point, | 217 | ° C. | DIN 53765 DSC 7 v. Perkin Elmer, heating/cooling |
| 1^{st} heating | | | rate 20 K/min |
| procedure | | | |
| Recrystallization | 168 | ° C | DIN 53765 DSC 7 v. Perkin Elmer, heating/cooling |
| temperature | | | rate 20 K/min |

| | |
|---|---|
| Conditioning | Material is stored for 24 h at 23° C. and 50% humidity prior to |
| of the material | processing/analysis |

TABLE 3
Properties of polypropylene powder

| | Value | Unit | Test type/Test equipment/Test parameters |
|---|---|---|---|
| Polymer | Polypropylene | | |
| Bulk density | 0.358 | g/cm³ | DIN EN ISO 60 |
| Grain size d50 | 31 | μm | Malvern Mastersizer 2000, dry measurement, 20-40 g |
| | | | of powder added by means of Scirocco dry |
| | | | dispersion equipment. |
| | | | Feed rate vibratory trough 70%, dispersion air |
| | | | pressure 3 bar. Specimen measurement time |
| | | | 5 seconds (5000 individual measurements), |
| | | | refractive index and blue-light value defined as |
| | | | 1.52. |
| | | | Evaluation by way of Mie theory |
| Grain size d10 | 19 | μm | Malvern Mastersizer 2000, parameters: see grain |
| | | | size d50 |
| Grain size d90 | 43 | μm | Malvern Mastersizer 2000, parameters: see grain |
| | | | size d50 |
| <10.48 μm | 1 | % | Malvern Mastersizer 2000, parameters: see grain |
| | | | size d50 |
| Pourability | Does not flow | s | DIN EN ISO 6186, Method A, nozzle outlet |
| | under test | | diameter 15 mm |
| | conditions | | |
| BET (spec. | 0.4 | m²/g | ISO 9277, Micromeritics TriStar 3000, nitrogen |
| surface area) | | | gas adsorption, discontinuous volumetric method, |
| | | | 7 measurement points at relative pressures P/P0 |
| | | | from about 0.05 to about 0.20, dead volume |
| | | | calibration by means of He(99.996%), specimen |
| | | | preparation 1 h at 23° C. + 16 h at 80° C. in vacuo, |
| | | | spec. surface area based on devolatilized specimen, |
| | | | evaluation by means of multipoint determination |
| Melting point, | 139 | ° C. | DIN 53765 DSC 7 v. Perkin Elmer, |
| 1^{st} heating | | | heating/cooling rate 20 K/min |
| procedure | | | |
| Recrystallization | 97 | ° C. | DIN 53765 DSC 7 v. Perkin Elmer, |
| temperature | | | heating/cooling rate 20 K/min |

| | |
|---|---|
| Conditioning | Material is stored for 24 h at 23° C. and 50% humidity prior to |
| of the material | processing/analysis |

TABLE 4
Properties of PEEK powder

| | Value | Unit | Test type/Test equipment/Test parameters |
|---|---|---|---|
| Polymer | PEEK | | |
| Bulk density | 0.261 | g/cm³ | DIN EN ISO 60 |
| Grain size d50 | 19 | μm | Malvern Mastersizer 2000, dry measurement, 20-40 g |
| | | | of powder added by means of Scirocco dry |
| | | | dispersion equipment. |
| | | | Feed rate vibratory trough 70%, dispersion air |
| | | | pressure 3 bar. Specimen measurement time |
| | | | 5 seconds (5000 individual measurements), |
| | | | refractive index and blue-light value defined as |
| | | | 1.52. |
| | | | Evaluation by way of Mie theory |
| Grain size d10 | 10 | μm | Malvern Mastersizer 2000, parameters: see grain |
| | | | size d50 |
| Grain size d90 | 37 | μm | Malvern Mastersizer 2000, parameters: see grain |
| | | | size d50 |
| <10.48 μm | 10 | % | Malvern Mastersizer 2000, parameters: see grain |
| | | | size d50 |
| Pourability | Does not flow | s | DIN EN ISO 6186, Method A, nozzle outlet |
| | under test | | diameter 15 mm |
| | conditions | | |
| Solution | 1.61 | — | ISO 307, Schott AVS Pro, solvent sulphuric acid, |
| viscosity | | | volumetric method, two measurements, dissolution |
| | | | temperature 100° C., dissolution time 2 h, polymer |
| | | | concentration 5 g/l, measurement temperature 25° C. |
| BET (spec. | 28 | m²/g | ISO 9277, Micromeritics TriStar 3000, nitrogen gas |
| surface area) | | | adsorption, discontinuous volumetric method, 7 |
| | | | measurement points at relative pressures P/P0 from |
| | | | about 0.05 to about 0.20, dead volume calibration |
| | | | by means of He(99.996%), specimen preparation |
| | | | 1 h at 23° C. + 16 h at 80° C. in vacuo, spec. surface |
| | | | area based on devolatilized specimen, evaluation by |
| | | | means of multipoint determination |
| Melting point, | 336 | ° C. | DIN 53765 DSC 7 v. Perkin Elmer, heating/cooling |
| 1^{st} heating | | | rate 20 K/min |
| procedure | | | |
| Recrystallization | 283 | ° C. | DIN 53765 DSC 7 v. Perkin Elmer, heating/cooling |
| temperature | | | rate 20 K/min |

| | |
|---|---|
| Conditioning | Material is stored for 24 h at 23° C. and 50% humidity prior to |
| of the material | processing/analysis |

1. An apparatus for layer-by-layer production of three-dimensional objects, comprising:
a construction chamber having a planar base;
an adjustable-height construction platform comprising a construction field contingent with the planar base,
an electromagnetic radiation source having a control unit and a lens; and
a moveable material application unit on the planar base, the unit comprising at least one doctor blade;
wherein
a beam of electromagnetic radiation emitted from the source is focused by the lens on an object area of the construction platform,
a height of the construction platform is adjustable in a downward direction perpendicular to the planar base,
the material application unit slides in a direction across the construction field,
the doctor blade of the material application unit is moveable in a direction parallel to the plane of the base and in a direction perpendicular to the direction of material application, and
an edge of the doctor blade closest to the construction field is a non-continuous straight line.

2. The apparatus according to claim 1 wherein the edge of the doctor blade comprises at least two recesses and a geometric shape of the recesses is selected from the group consisting of semicircular, triangular, trapezoidal and rectangular.

3. The apparatus according to claim 2, wherein the at least two recesses are triangular or trapezoidal and have peaks pointing to the construction field.

4. The apparatus according to claim 3, wherein an angle of the edge between the triangular or trapezoidal peaks is 150° or less.

5. The apparatus according to claim 2 wherein an amount of recess length is from 30 to 70% of a total length of the doctor blade edge.

6. The apparatus according to claim 1 wherein a shape of the non-continuous straight line of the edge of the doctor blade closest to the construction field is a comb structure.

7. The apparatus according to claim 1, further comprising at least one additional material application unit.

8. The apparatus according to claim 1, wherein the material application unit comprises a vibration generator.

9. The apparatus according to claim 8, wherein the vibration generator vibrates the doctor blade in the direction perpendicular to the direction of material application.

10. The apparatus according to claim 9, wherein an amplitude of the doctor blade vibration is from 1 mm to 10 mm and a frequency of the vibration is from 10 Hz to 200 Hz.

11. The apparatus according to claim 1, further comprising a roller or a wiper which is conveyed across the plane of the construction field to smooth the surface of the applied powder.

12. The apparatus according to claim 1, further comprising a vibration generator, which sets the construction platform (6) into vibration.

13. The apparatus according to claim 1, wherein the at least one doctor blade comprises more than one doctor blade and each doctor blade has a same geometrical shape.

14. The apparatus according to claim 1, wherein the at least one doctor blade comprises more than one doctor blade and a geometrical shape of at least one doctor blade is different from the other doctor blade or blades.

15. The apparatus according to claim 9, wherein the at least one doctor blade comprises more than one doctor blade and a geometrical shape of at least one doctor blade is different from the other doctor blade or blades.

16. A process for layer-by-layer production of three-dimensional objects, comprising:
applying a powder layer onto a construction platform having a planar base;
irradiating the powder with a beam of electromagnetic radiation to fuse the powder in an object pattern;
solidifying the fused powder; and
repeating the powder layer application, irradiation and solidification the obtain a three-dimensional object;
wherein
the powder layer is applied with a moveable material application unit comprising a doctor blade,
an edge of the doctor blade closest to the construction platform is a non-continuous straight line,
the application unit is moved across the construction platform parallel to the planar base, and
the doctor blade is additionally moved in a direction perpendicular to the direction of the application unit across the construction platform and parallel to the planar construction platform.

17. The method according to claim 16, further comprising:
loosening the powder prior to application by translational or rotational movement of the powder;
wherein the powder is loosened during application or during metering of the powder.

18. The method according to claim 16, further comprising: cleaning the application unit with a stripping apparatus to remove powder which adheres to apparatus.

19. The method according to claim 16, wherein the applied powder is a polymer powder having an average grain size d50 of less than 50 μm and is non-flowable for the layer-by-layer production of three-dimensional objects according to DIN EN ISO 6186 (method A, flow diameter 15 mm).

20. A three dimensional object or article obtained by the process according to claim 16.
